(19) United States
(12) Patent Application Publication
(10) Pub. No.: US 2025/0372123 A1
(43) Pub. Date: Dec. 4, 2025

(54) NON-TRANSITORY RECORDING MEDIUM, VIDEO OUTPUT APPARATUS, AND VIDEO OUTPUT METHOD

(71) Applicant: Roland Corporation, Shizuoka (JP)

(72) Inventor: Yoshihide Kasai, Shizuoka (JP)

(73) Assignee: Roland Corporation, Shizuoka (JP)

(21) Appl. No.: 18/826,167

(22) Filed: Sep. 5, 2024

(30) Foreign Application Priority Data
May 29, 2024 (JP) 2024-086847

(51) Int. Cl. G11B 27/031

(52) U.S. Cl. CPC G11B 27/031

(57) ABSTRACT

A non-transitory recording medium stores a video output program for causing a computer, to which an external device is connected, to execute a process of outputting a content video that is a video created based on contents including at least one of a video and an image. The contents include content data in which a configuration of the content video is written in a human-readable format. The computer includes an output part that generates the content video based on the content data and outputs the content video to the external device, and the video output program causes the computer to load content data included in an output target content selected from a plurality of the contents into the output part and output a content video based on the content data to the external device.

### CROSS-REFERENCE TO RELATED APPLICATION

This application claims the priority benefits of Japanese application no. 2024-086847, filed on May 29, 2024. The entirety of the above-mentioned patent application is hereby incorporated by reference herein and made a part of this specification.

### BACKGROUND

### Technical Field

The disclosure relates to a non-transitory recording medium, a video output apparatus, and a video output method.

### Description of Related Art

Patent Document 1 discloses an information processing apparatus 1 that produces telop data and provides the produced telop data to an image distribution system 5. Specifically, the user inputs material data that includes text information and selects a template that determines the display mode of telop, and telop data is produced by applying the selected template to the input material data. A video with the produced telop data superimposed thereon is distributed from the image distribution system 5 to a distribution destination, which allows the user to easily create telop data in a desired display mode using a template and distribute the telop data to the distribution destination.

### RELATED ART

### Patent Document

[Patent Document 1] Japanese Patent Application Laid-Open No. 2020-137075

However, the telop configuration data describing the configuration of such telop is generally binary data or the like, which is problematic because such data is human-unreadable. In addition, dedicated software is required when editing such telop configuration data, which poses the problem that it is difficult for the user to directly edit the telop configuration data to create the desired telop configuration.

The disclosure provides a non-transitory recording medium, a video output apparatus, and a video output method that allow the user to easily change the configuration of a content.

### SUMMARY

A non-transitory recording medium according to an embodiment of the disclosure stores a video output program for causing a computer, to which an external device is connected, to execute a process of outputting a content video that is a video created based on contents including at least one of a video and an image. The contents include content data in which a configuration of the content video is written in a human-readable format. The computer includes an output part that generates the content video based on the content data and outputs the content video to the external device, and the video output program causes the computer to load content data included in an output target content selected from a plurality of the contents into the output part and output a content video based on the content data to the external device.

A video output apparatus according to an embodiment of the disclosure is an apparatus configured to output a content video that is a video created based on contents including at least one of a video and an image. The contents include content data in which a configuration of the content video is written in a human-readable format. The video output apparatus includes a processor configured to: load content data included in an output target content selected from a plurality of the contents into an output part and output a content video based on the content data to an external device.

Further, a video output method according to an embodiment of the disclosure is a method for outputting a content video that is a video created based on contents including at least one of a video and an image. The contents include content data in which a configuration of the content video is written in a human-readable format. The video output method includes: loading content data included in an output target content selected from a plurality of the contents into an output part and outputting a content video based on the content data to an external device.

### BRIEF DESCRIPTION OF THE DRAWINGS

FIG. 1 is a diagram showing the external appearance of a PC.

FIG. 2A is a diagram showing a display screen, FIG. 2B to FIG. 2E are diagrams illustrating content buttons, FIG. 2F is a diagram illustrating a composite content button, and FIG. 2G is a diagram illustrating a composite creation button.

FIG. 3A and FIG. 3B are diagrams illustrating a user content area in a case where an auto tab is selected.

FIG. 4A to FIG. 4D are diagrams illustrating an editing screen.

FIG. 5 is a block diagram showing the electrical configuration of the PC.

FIG. 6A is a diagram illustrating a video output program, and FIG. 6B is a diagram schematically showing a content table.

FIG. 7A is a diagram illustrating content data, and FIG. 7B is a diagram illustrating editing screen data.

FIG. 8 is a functional block diagram of the PC.

FIG. 9 is a sequence diagram showing a content start process.

FIG. 10A is a sequence diagram showing a content deselection process, FIG. 10B is a flowchart of a content selection process, and FIG. 10C is a flowchart of an editing switching process.

FIG. 11 is a sequence diagram of a content editing process.

FIG. 12A is a sequence diagram of a case where a content or editing screen is controlled from a MIDI device or a video switcher, and FIG. 12B is a sequence diagram of a case where the MIDI device or the video switcher is controlled from a content.

### DESCRIPTION OF THE EMBODIMENTS

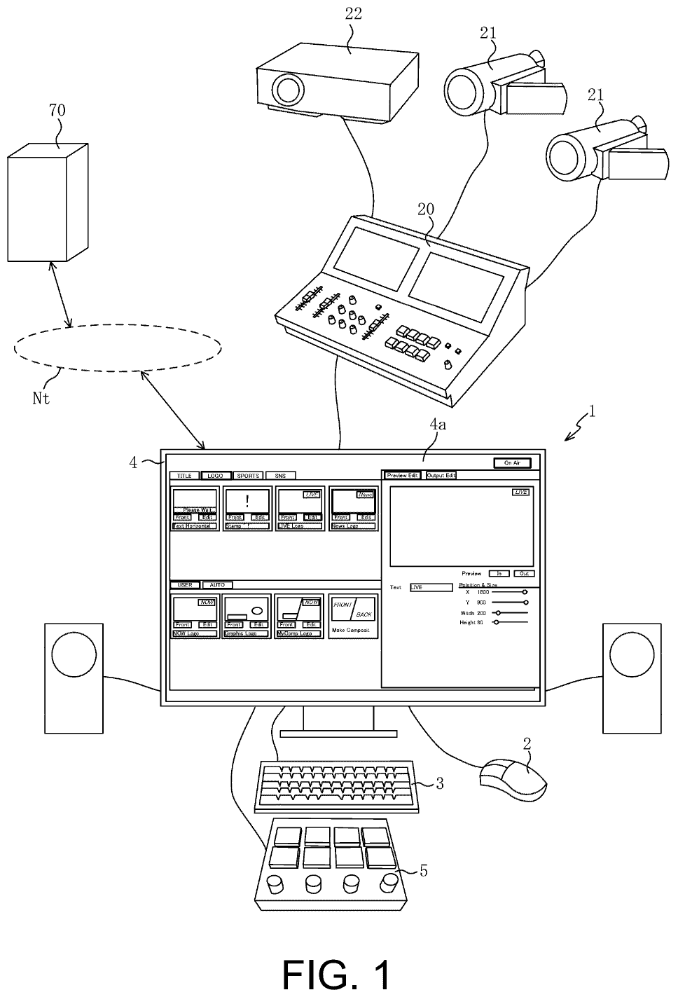

Exemplary embodiments will be described hereinafter with reference to the accompanying drawings. The overview of a PC 1 according to this embodiment will be described with reference to FIG. 1. FIG. 1 is a diagram illustrating the outline of the PC 1. The PC 1 is an information processing apparatus (computer, video output apparatus, and a like) that outputs a content video to a connected video switcher 20 (which will be described later).

The content in this embodiment refers to a set of data composed of one or more pieces of video, image, or audio data, and content data (which will be described later) for creating a content video, which is a new video, from these data. In addition to video and image, audio such as human voices and background music can be added to the content video. Such content is created in the PC 1, and the content video of the created content is transmitted to the video switcher 20.

The PC 1 includes a mouse 2 and a keyboard 3 for inputting an instruction from a user H, a display device 4 for displaying information such as content, and a MIDI device 5. The MIDI device 5 is a device for inputting a MIDI (Musical Instrument Digital Interface) message based on an operation of the user H. The PC 1 performs processing in accordance with the MIDI message input from the MIDI device 5.

Examples of the MIDI device 5 include a controller which has multiple buttons each having a MIDI message assigned thereto and which transmits the MIDI message corresponding to the button pressed by the user H, and a keyboard type musical keyboard which transmits MIDI messages assigned to the keys, but any device that uses MIDI messages may also be used as appropriate. The PC 1 performs processing such as selecting a content according to the MIDI message input from the MIDI device 5 and switching functions assigned to buttons of the MIDI device 5 based on the MIDI message output from the PC 1.

The PC 1 is further connected to the video switcher 20 and a server 70. The video switcher 20 is a device (external device, video processing device, and a like) that outputs a composite video, which is a video in which input images and videos are arranged into one video. Multiple video cameras 21 and a projector 22 are connected to the video switcher 20. The video camera 21 is an input device to which images and videos to be arranged in the composite video are input, and the projector 22 is an output device that projects the composite video from the video switcher 20 onto a screen.

The video switcher 20 creates a composite video by superimposing the content video input from the PC 1 on the images and videos input from the multiple video cameras 21, and outputs the created composite video to the projector 22.

The server 70 is an information processing device that transmits a content to the PC 1, and is connected to the PC 1 via Internet Nt. The server 70 stores multiple contents created in advance, and the content selected by the PC 1, among the stored contents, is transmitted to the PC 1. In addition, the content that has already been transmitted from the server 70 and stored in the PC 1 can be used offline without being acquired again from the server 70. Furthermore, the user H can not only acquire the contents from the server 70 and edit the contents acquired from the server 70, but also create a new content.

The PC 1 outputs a content video based on the content newly created by the user H to the video switcher 20, and also outputs a content video based on the content transmitted from the server 70 to the video switcher 20 directly. Furthermore, a content video based on a content that has been edited from the server 70 (for example, by changing a character string included in the content to other words) is output to the video switcher 20.

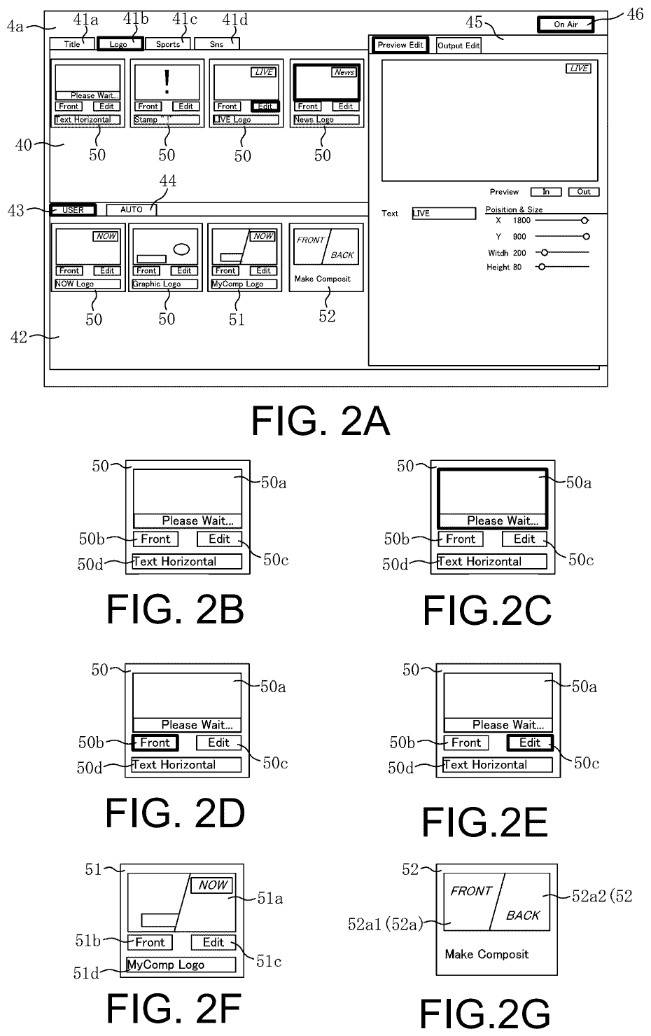

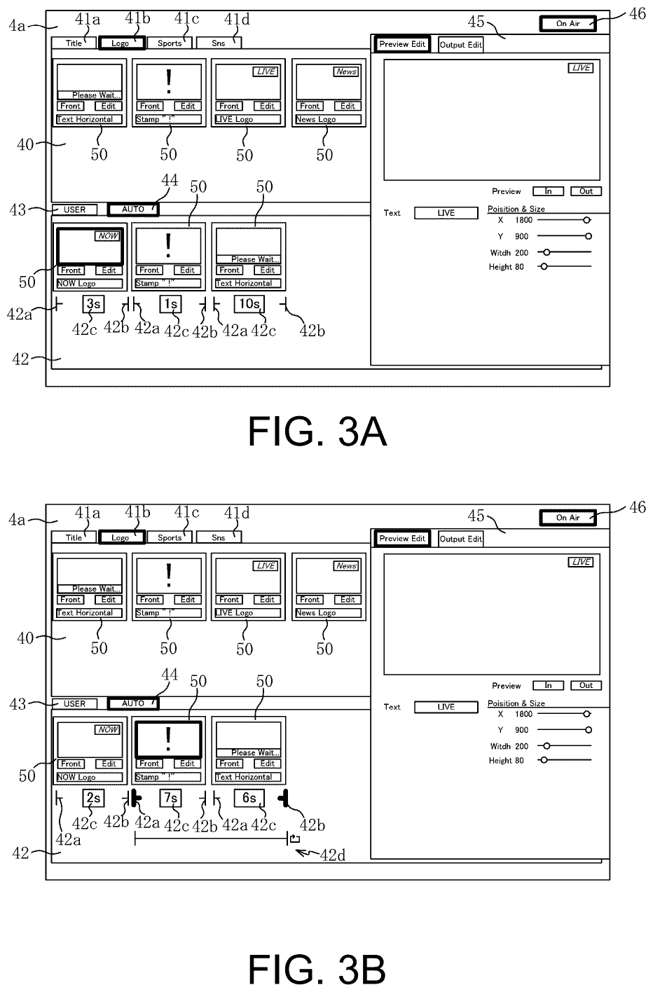

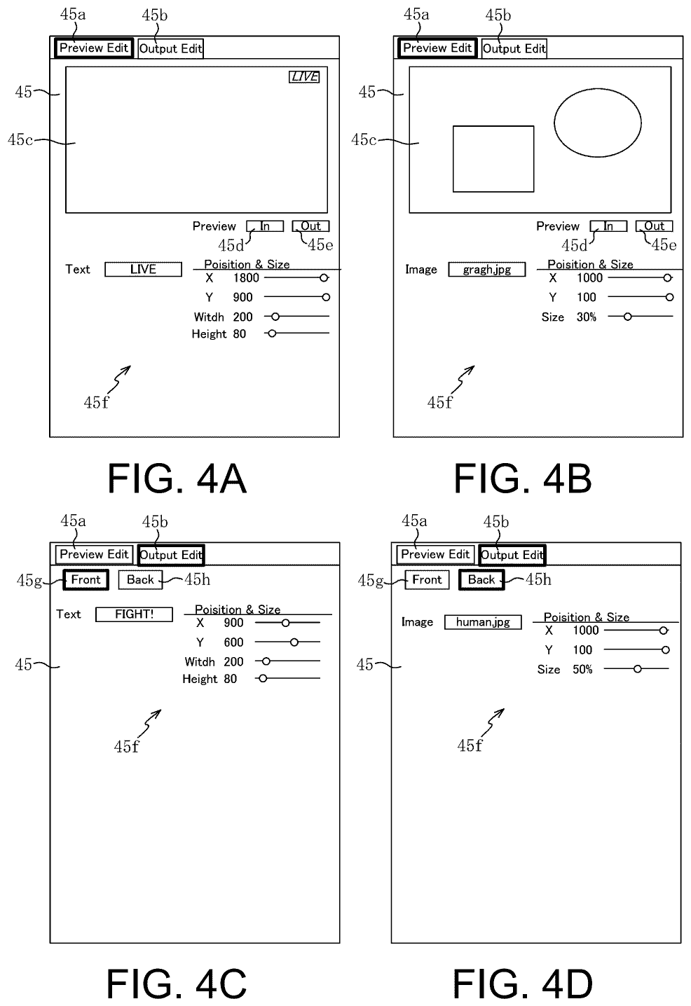

In the PC 1 of this embodiment, a display screen 4a displayed on the display device 4 allows the user H to select an output target content that is the content to be output to the video switcher 20, and edit the aspect of the content. The display screen 4a will be described with reference to FIG. 2A to FIG. 2G, FIG. 3A to FIG. 3B, and FIG. 4A to FIG. 4D.

FIG. 2A is a diagram showing the display screen 4a. The display screen 4a displays a preset content area 40, category tabs 41a to 41d, a user content area 42, a user tab 43, an auto tab 44, an editing screen 45, and an on air button 46 that starts/ends the output of the content video based on the output target content to the video switcher 20.

The preset content area 40 is a display area in which a list of contents stored in the server 70 is displayed. The category tabs 41a to 41d are buttons for selecting categories of the contents to be displayed in the preset content area 40. The contents stored in the server 70 are pre-classified into categories such as “Title” and “Logo”, and the contents of the categories corresponding to the selected category tabs 41a to 41d are displayed in the preset content area 40.

Content buttons 50 are displayed in the preset content area 40, which represent the contents corresponding to the categories selected in the category tabs 41a to 41d. The content buttons 50 will be described in detail later with reference to FIG. 2B to FIG. 2E.

The user content area 42 is a display area in which a list of contents or sequences created or edited by the user H is displayed. The user tab 43 is a button for switching the contents displayed in the user content area 42 to the contents created or edited by the user H. Moreover, the auto tab 44 is a button for switching the contents displayed in the user content area 42 to the contents that constitute a sequence.

Here, the sequence is obtained by arranging multiple contents at the output timings. The contents arranged in the sequence are output at specified timings in the order in which the contents are arranged (for example, a certain content is output for 30 seconds, and the next content is displayed for 20 seconds, etc.).

In a case where the user tab 43 is selected, the user content area 42 displays the content buttons 50 representing the contents corresponding to the contents created or edited by the user H, a composite content button 51 representing a composite content that combines two separate contents into one content, and a composite creation button 52 for creating the composite content.

In a case of creating contents, the user H drags and drops the content button 50 displayed in the preset content area 40 into the user content area 42. By doing so, the content is copied and placed in the user content area 42. The user H can easily construct a content in the aspect desired by the user H by editing the copied content. The display content of the user content area 42 in a case where the auto tab 44 is selected will be described later with reference to FIG. 3A and FIG. 3B.

Next, the content buttons 50 will be described with reference to FIG. 2B to FIG. 2E. FIG. 2B to FIG. 2E are diagrams illustrating the content buttons 50. As shown in FIG. 2B to FIG. 2E, the content button 50 displays a thumbnail button 50a, a foreground button 50b, an editing button 50c, and a name area 50d.

The thumbnail button 50a is a button for displaying the display content (thumbnail) of the corresponding content and for selecting the content as a background content which is one of the output target contents.

In this embodiment, two contents can be selected at the same time as the output target contents. A foreground content is provided which is the content displayed in front (foreground) among the two contents, and a background content is provided which is the content displayed behind (background) the foreground content. A content video in a form that the foreground content is superimposed in front of the background content is output to the video switcher 20.

In a case where the thumbnail button 50a is selected and the corresponding content is selected as the background content, the outer frame of the thumbnail button 50a is drawn with a thick line, as shown in FIG. 2C, to indicate that the corresponding content has been selected as the background content.

Further, in a state where the thumbnail button 50a of one content button 50 has been selected, when the thumbnail button 50a of the other content button 50 is selected, the content corresponding to the one content button 50 selected as the background content is deselected, and the content corresponding to the other content button 50 is selected as the background content. Then, the outer frame of the thumbnail button 50a of the one content button 50 is changed to a normal line (that is, the thickness shown in FIG. 2B), and the outer frame of the thumbnail button 50a of the other content button 50 is changed to a thick line (that is, FIG. 2C). Such an operation can prevent multiple contents from being selected as the background content at the same time.

The foreground button 50b is a button (operator) for selecting the corresponding content as the foreground content. In a case where the foreground button 50b is selected and the corresponding content is selected as the foreground content, the outer frame of the foreground button 50b is drawn with a thick line, as shown in FIG. 2D, to indicate that the corresponding content has been selected as the foreground content.

In a case where the thumbnail button 50a or the foreground button 50b of the content button 50 is selected in this manner from the preset content area 40 or the user content area 42 in which a list of contents is displayed, a content video based on the corresponding content starts to be output to the video switcher 20. On the other hand, in a case where the selected thumbnail button 50a or foreground button 50b is selected again, the output of the content video of the corresponding content to the video switcher 20 is stopped.

Since the user H can select and deselect the output target content in this manner to instantly and easily start and stop the output of the output target content to the video switcher 20, the content desired by the user H can be output to the video switcher 20 at the timing intended by the user H.

In addition, one content is selected as the background content when the thumbnail button 50a corresponding to the one content is selected, and the other content is selected as the foreground content when the foreground button 50b corresponding to the other content is selected. Then, a content video in a form that the foreground content is superimposed on the selected background content is output to the video switcher 20. This makes it possible to output to the video switcher 20 an expressive content video that combines two types of contents, the foreground content and the background content that are different from each other.

Furthermore, the user H can switch the background content and the foreground content with each other by selecting the foreground button 50b of the content designated as the background content and the thumbnail button 50a of the content designated as the foreground content. For example, by switching the foreground content and the background content according to the video from the video camera 21 in the video switcher 20, a content suitable for the video from the video camera 21 can be easily output.

Here, the transparency (alpha channel) is preset in the content according to the images and videos that constitute the content. In a case where the foreground content and the background content are superimposed, the foreground content and the background content are superimposed after applying the transparency set for each of the foreground content and the background content. Thus, for a content video that has the foreground content superimposed on the background content, the background content can be prevented from being covered by the foreground content, which may make the background content completely invisible.

The editing button 50c is a button for selecting the target content to be edited on the editing screen 45. In a case where the editing button 50c is selected, the target content to be edited on the editing screen 45 is selected to be the content corresponding to the selected editing button 50c, and at this time, the outer frame of the editing button 50c is drawn with a thick line, as shown in FIG. 2E. Details of the editing screen 45 will be described later with reference to FIG. 4A to FIG. 4D. The name area 50d is a display area in which the name given to the corresponding content is displayed.

Next, the composite content button 51 and the composite creation button 52 will be described with reference to FIG. 2F and FIG. 2G. FIG. 2F is a diagram illustrating the composite content button 51. As shown in FIG. 2F, the composite content button 51 displays a thumbnail button 51a, a foreground button 51b, an editing button 51c, and a name area 51d.

The thumbnail button 51a and the foreground button 51b are buttons for selecting the corresponding composite content. In a state where no composite content is selected, by operating the thumbnail button 51a or the foreground button 51b, the background content of the composite content corresponding to the selected thumbnail button 51a or foreground button 51b is selected as the background content. At the same time, the foreground content of the composite content corresponding to the selected thumbnail button 51a or foreground button 51b is selected as the foreground content. The thumbnail button 51a and the foreground button 51b have the same functions as the thumbnail button 50a and the foreground button 50b described above in a case where a composite content is selected, and therefore a detailed description thereof will be omitted. In addition, the editing button 51c and the name area 51d have the same functions as the editing button 50c and the name area 50d described above, and therefore a detailed description thereof will be omitted.

Next, the composite creation button 52 will be described. FIG. 2G is a diagram illustrating the composite creation button 52. The composite creation button 52 is a button for creating a composite content. As shown in FIG. 2G, the composite creation button 52 displays a content designation area 52a. The content designation area 52a is a display area for designating the contents that constitute the composite content, and specifically, a foreground content designation area 52al for designating the foreground content and a background content designation area 52a2 for designating the background content are provided.

The creation of a composite content using the composite creation button 52 will be described below. First, the content button 50 of the content to be used as the foreground content in the composite content is selected from the preset content area 40 or the user content area 42, and is dragged and dropped into the foreground content designation area 52al. Then, the content button 50 of the content to be used as the background content in the composite content is selected from the preset content area 40 or the user content area 42, and dragged and dropped into the background content designation area 52a2.

By dragging and dropping the content button 50 into the content designation area 52a in this manner, a composite content is created based on the corresponding content. In the above description, the foreground content is designated first and then the background content is designated. However, the background content may be designated before the foreground content. Then, the composite content button 51 of the created composite content is displayed in the user content area 42.

By creating one composite content using two contents respectively as the foreground content and the background content in this manner, a content video that combines the foreground content and the background content can be easily and quickly output to the video switcher 20.

Next, the user content area 42 in a case where the auto tab 44 is selected will be described with reference to FIG. 3A and FIG. 3B. FIG. 3A and FIG. 3B are diagrams illustrating the user content area 42 in a case where the auto tab 44 is selected.

First, the content button 50 corresponding to the content to be sequenced is copied from the preset content area 40 by dragging and dropping the content button 50 into the user content area 42 in a case where the auto tab 44 is selected. In addition, the content button 50 displayed in the user content area 42 in a case where the user tab 43 is selected may be copied into the user content area 42 in a case where the auto tab 44 is selected.

In this manner, in a case where the auto tab 44 is selected, the content corresponding to the content button 50 arranged in the user content area 42 is set as the target content for the sequence. Then, the contents are switched in order from the content selected by the user H to the right to output the corresponding content video, and when the output of the content video based on the rightmost content is completed, the output of the content video is stopped.

A start point designation button 42a, an end point designation button 42b, and a duration designation area 42c are displayed below the content button 50 in the user content area 42 in a case where the auto tab 44 is selected.

The start point designation button 42a is a button for designating the content of the corresponding content button 50 as a start point content which is the first content when looping the sequence. In a case where the start point designation button 42a is selected, the start point designation button 42a is drawn with a thick line, as shown in FIG. 3A and FIG. 3B, to indicate that the corresponding content has been designated as the start point content.

The end point designation button 42b is a button for designating the content of the corresponding content button 50 as an end point content which is the last content when looping the sequence. In a case where the end point designation button 42b is selected, the end point designation button 42b is drawn with a thick line, as shown in FIG. 3A and FIG. 3B, to indicate that the corresponding content has been designated as the end point content.

In a case where the end point designation button 42b is selected, it is set to loop the sequence, and the content of the content button 50 selected by the start point designation button 42a, or if the start point designation button 42a is not selected, the leftmost content, the content of the content button 50 designated by the end point designation button 42b, and the contents arranged between these content buttons 50 are set as the targets of the sequence to be looped. When the selected end point designation button 42b is selected again and then deselected, the setting for looping the sequence is cancelled.

Further, the duration designation area 42c is a display area for designating the time (seconds) for which the content of the corresponding content button 50 is to be output. The time for outputting the content set in the duration designation area 42c is used for both a case where the sequence is looped and a case where the sequence is not looped.

A loop target display 42d is displayed below the start point designation button 42a, the end point designation button 42b, and the duration designation area 42c. The loop target display 42d is a display part that is displayed across the content buttons 50 to be looped for the sequence. By visually checking the loop target display 42d, the user H can easily understand the range of the contents set as the targets of the sequence.

Here, an example of the output of the sequence in FIG. 3A and FIG. 3B will be described. In FIG. 3A, since none of the end point designation buttons 42b are selected, it is set not to loop the sequence. In addition, the duration designation area 42c corresponding to the leftmost content button 50 is set to “3 seconds”, the duration designation area 42c corresponding to the second content button 50 from the left is set to “1 second”, and the duration designation area 42c corresponding to the rightmost content button 50 is set to “10 seconds”.

Thus, first, the content video of the content corresponding to the leftmost content button 50 selected by the user H is output to the video switcher 20 for 3 seconds, then the content video of the content corresponding to the second content button 50 from the left is output to the video switcher 20 for 1 second, and then the content video of the content corresponding to the rightmost content button 50 is output to the video switcher 20 for 10 seconds. Then, in a case where the output of the content video of the content corresponding to the rightmost content button 50 to the video switcher 20 is completed, the output of the content video is stopped.

On the other hand, in FIG. 3B, the start point designation button 42a of the second content button 50 from the left is selected, and the end point designation button 42b of the rightmost content button 50 is selected. Thus, it is set to loop the sequence. In addition, the duration designation area 42c corresponding to the second content button 50 from the left is set to “7 seconds”, and the duration designation area 42c corresponding to the rightmost content button 50 is set to “6 seconds”.

Thus, first, the content video of the content corresponding to the second content button 50 from the left is output to the video switcher 20 for 7 seconds, and then the content video of the content corresponding to the rightmost content button 50 is output to the video switcher 20 for 6 seconds. After the output of the content corresponding to the rightmost content button 50 to the video switcher 20 is completed, the output of the content corresponding to the second content button 50 from the left to the video switcher 20 is repeated again.

Further, as shown in FIG. 3B, in a state where the start point designation button 42a of the second content button 50 from the left is selected and the end point designation button 42b of the rightmost content button 50 is selected, when the thumbnail button 50a of the leftmost content button 50 is selected, first, the content video of the content corresponding to the leftmost content button 50 is output to the video switcher 20 for 2 seconds, then the content video of the content corresponding to the second content button 50 from the left is output to the video switcher 20 for 7 seconds, and then the content video of the content corresponding to the rightmost content button 50 is output to the video switcher 20 for 6 seconds.

After the output of the content corresponding to the rightmost content button 50 to the video switcher 20 is completed, the output of the content corresponding to the second content button 50 from the left for which the start point designation button 42a is selected, and then the content corresponding to the rightmost content button 50 is repeated. That is, in a state where the start point designation button 42a and the end point designation button 42b are selected, when the thumbnail button 50a of the content button 50 to the left of the start point designation button 42a is also selected, the content corresponding to the content button 50 to the left of the start point designation button 42a is output only for the first time of the loop, and thereafter the content selected by the start point designation button 42a to the content selected by the end point designation button 42b are output repeatedly.

In this manner, a sequence is created in which multiple contents are arranged according to the timings of output, and a content video based on the target contents is output to the video switcher 20 according to the timings set in the sequence. This allows the user H to automatically switch the contents to be output at preset timings, without selecting the thumbnail buttons 50a, etc. one by one in order in real time.

Next, the editing screen 45 will be described with reference to FIG. 4A to FIG. 4D. FIG. 4A to FIG. 4D are diagrams illustrating the editing screen 45. As shown in FIG. 4A to FIG. 4D, the editing screen 45 mainly displays a preview editing button 45a, an output content editing button 45b, a preview area 45c, a start animation preview button 45d, an end animation preview button 45e, and an editing part group 45f.

The preview editing button 45a is a button for designating the target for editing the aspect of the content on the editing screen 45 to be the content of the content button 50 for which the above-mentioned editing buttons 50c and 51c are selected. Here, the aspect of the content refers to settings related to the display of the components that make up the content, such as the images and videos that constitute the content, their arrangement and size, and the content and color of the character string that constitutes the content.

In addition, the output content editing button 45b is a button for designating the target for editing the aspect of the content on the editing screen 45 to be the background content and foreground content selected by the thumbnail buttons 50a and 51a and the foreground buttons 50b and 51b. The preview editing button 45a and the output content editing button 45b are configured so that only one can be selected, and the outer frame of the selected button is drawn with a thick line.

The preview area 45c is a display area for displaying the display content of the content being edited. The display content of the content as a result of editing using the editing part group 45f (which will be described later) is displayed in the preview area 45c.

The start animation preview button 45d is a button for displaying a start animation of the content to be edited in the preview area 45c. The start animation is an animation that is output immediately after the output of the content is started. In a case where the content to be edited includes a start animation, the start animation is displayed in the preview area 45c by selecting the start animation preview button 45d.

The end animation preview button 45e is a button for displaying an end animation of the content to be edited in the preview area 45c. The end animation is an animation that is output immediately before the output of the content is completed, and in a case where the content to be edited includes an end animation, the end animation is displayed in the preview area 45c by selecting the end animation preview button 45e.

The editing part group 45f is a group of parts for changing the settings of the aspect of the content to be edited. In the editing part group 45f, different parts are arranged for each content to be edited. For example, the editing screen in FIG. 4A displays a part for changing the content (“LIVE”) of the character string to be displayed as the content, and parts for setting the position of the character string in the X- and Y-axis directions, width, and height. Further, the editing screen in FIG. 4B, which is for editing a content aspect different from FIG. 4A, displays a part for specifying the file name (“graph.png.”) of the image to be displayed as the content and parts for setting the position of the image in the X- and Y-axis directions and the enlargement factor.

By displaying parts corresponding to the content to be edited in the editing part group 45f in this manner, the user H can easily and intuitively edit the aspect of the content.

Next, the editing screen 45 in a case where the output content editing button 45b is selected will be described with reference to FIG. 4C and FIG. 4D. In a case where the output content editing button 45b is selected, the editing screen 45 displays the above-mentioned editing part group 45f, a foreground editing button 45g, and a background editing button 45h. Although the preview area 45c is omitted from FIG. 4C and FIG. 4D, the preview area 45c may be displayed even when the output content editing button 45b is selected.

The foreground editing button 45g is a button for designating the target for editing the aspect of the content on the editing screen 45 to be the foreground content. Further, the background editing button 45h is a button for designating the target for editing the aspect of the content on the editing screen 45 to be the background content. The foreground editing button 45g and the background editing button 45h are configured so that only one can be selected, and the outer frame of the selected button is drawn with a thick line.

Even in a case where the output content editing button 45b is selected, a part group is displayed as the editing part group 45f for changing the settings of the aspect of the foreground content or the background content designated by the foreground editing button 45g or the background editing button 45h. Then, the aspect of the content set by the editing part group 45f is applied to the foreground content or the background content designated by the foreground editing button 45g or the background editing button 45h, and is reflected in real time in the content video being output to the video switcher 20. This allows the foreground content or the background content to be quickly output to the video switcher 20 in the aspect intended by the user H.

Furthermore, the editing part group 45f for editing the aspect of the foreground content and the editing part group 45f for editing the aspect of the background content are switched by selecting the foreground editing button 45g or the background editing button 45h. That is, by selecting the foreground editing button 45g or the background editing button 45h, it is possible to easily switch between the editing screen 45 for editing the aspect of the foreground content and the editing screen 45 for editing the aspect of the background content. Thus, the respective aspects of the foreground content and the background content can be edited easily and quickly.

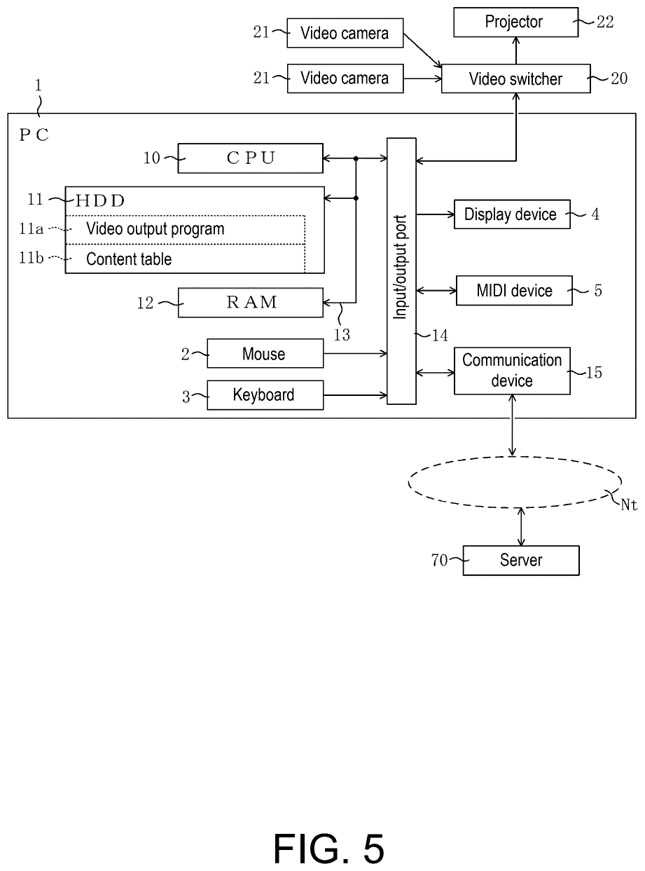

Next, the electrical configuration of the PC 1 will be described with reference to FIG. 5 to FIG. 7A and FIG. 7B. FIG. 5 is a block diagram showing the electrical configuration of the PC 1. The PC 1 includes a CPU 10, a hard disk drive (HDD) 11, and a RAM 12, which are respectively connected to an input/output port 24 via a bus line 13. The input/output port 24 is further connected to the above-mentioned mouse 2, keyboard 3, display device 4, MIDI device 5, video switcher 20, and a communication device 15.

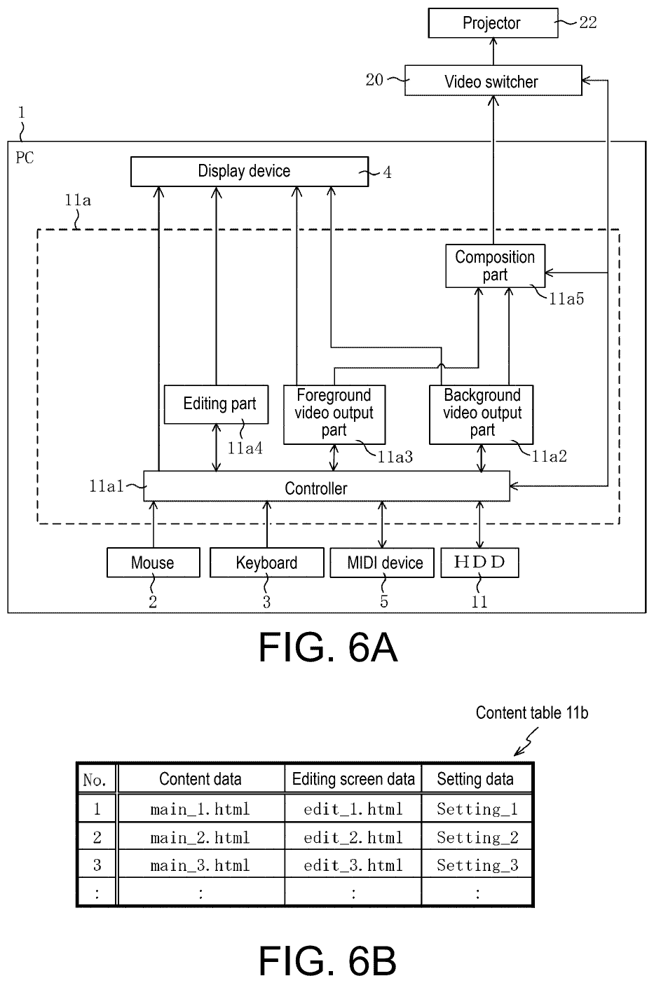

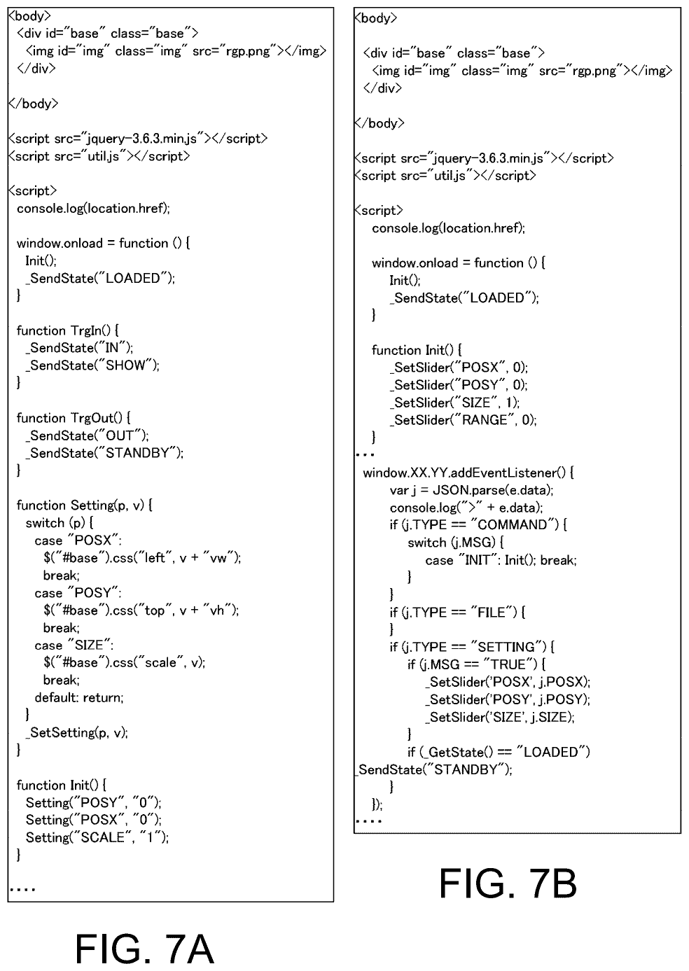

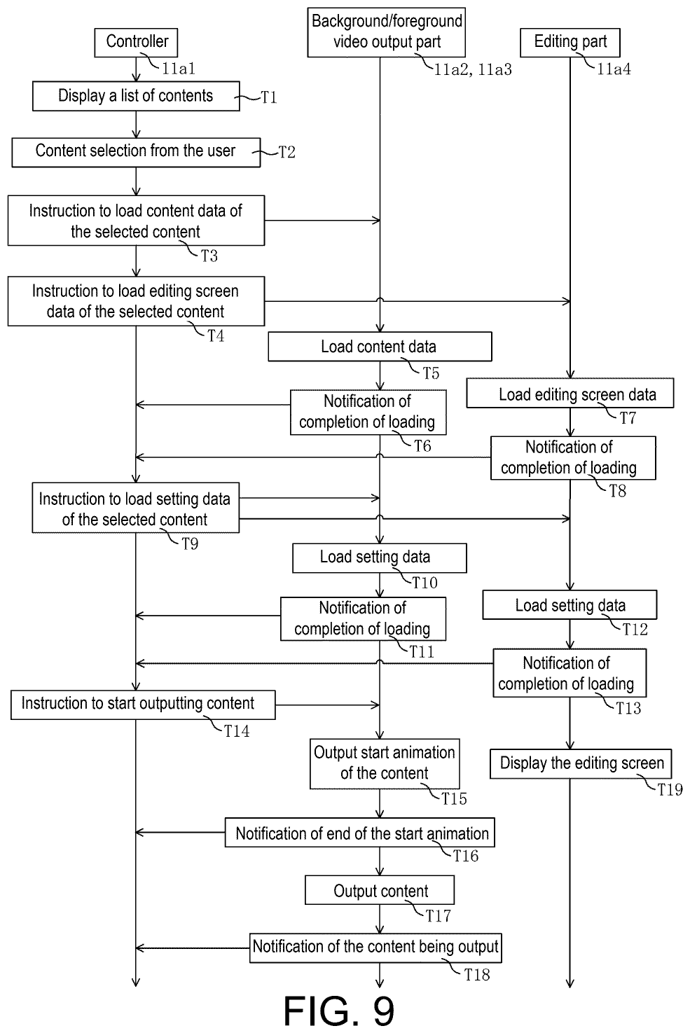

The CPU 10 is a computing device that controls each part connected by the bus line 13. The HDD 11 is a rewritable non-volatile storage device that stores programs to be executed by the CPU 10, fixed value data, etc., and stores a video output program 11a and a content table 11b. When the video output program 11a is executed in the CPU 10, the processes described below with reference to FIG. 9 to FIG. 12A and FIG. 12B are performed. The video output program 11a and the content table 11b will be described here with reference to FIG. 6A and FIG. 6B to FIG. 7A and FIG. 7B.

FIG. 6A is a diagram illustrating the video output program 11a. As shown in FIG. 6A, the video output program 11a includes the following modules: a controller 11a1, a background video output part 11a2, a foreground video output part 11a3, an editing part 11a4, and a composition part 11a5. The controller 11a1 is a module that controls other modules such as the background video output part 11a2, and other devices connected to the PC 1 such as the mouse 2, the display device 4, and the video switcher 20.

The background video output part 11a2 is a module that creates and outputs a background video which is a content video of the content selected as the background content by the controller 11a1. Although details will be described later, the configuration such as positions and sizes of the videos and images arranged in the background video are expressed by content data included in the content. In this embodiment, the content data is written in HTML

(HyperText Markup Language). The background video output part 11a2 interprets the HTML description of the content data corresponding to the selected background content, and outputs a background video which is a content video created based on the result of the interpretation. The created background video is transmitted to the display device 4 when displayed in the preview area 45c, and is transmitted to the composition part 11a5 (which will be described later) when output to the video switcher 20.

The foreground video output part 11a3 is a module that creates and outputs a foreground video of the content designated as the foreground content by the controller 11a1. The foreground video output part 11a3 also interprets the HTML description in the content data of the content corresponding to the selected foreground content, and outputs a foreground video created based on the result of the interpretation. The output foreground video is transmitted to the display device 4 when displayed in the preview area 45c, and is transmitted to the composition part 11a5 when output to the video switcher 20.

These background video output part 11a2 and foreground video output part 11a3 are the “output parts”, and will be referred to as “output parts 11a2 and 11a3” when there is no particular distinction therebetween.

The editing part 11a4 is a module that creates and outputs a video of the editing screen 45 of the content designated by the controller 11al. Although details will be described later, the video of the editing screen 45 is also constructed based on editing screen data written in HTML. The editing part 11a4 interprets the HTML description of the editing screen data corresponding to the designated content, and creates a video based on the result of the interpretation. The created video is transmitted to the display device 4 for display as the editing screen 45.

In this embodiment, the background video output part 11a2, the foreground video output part 11a3, and the editing part 11a4 are configured using “Web View2” produced by Microsoft (registered trademark), but other technologies may also be used as appropriate to interpret the HTML of the content data and the editing data and output videos.

The composition part 11a5 is a module that creates a new content video obtained by superimposing (compositing) the foreground video output from the foreground video output part 11a3 on the background video output from the background video output part 11a2. As described above, the background video output from the background video output part 11a2 and the foreground video output from the foreground video output part 11a3 each have a preset transparency, so a new content video is created by superimposing these content videos according to the transparencies thereof. The newly created content video is set to a transparency according to the transparencies respectively preset for the background vide output from the background video output part 11a2 and the foreground video output from the foreground video output part 11a3.

In this manner, the content video and transparency created by the composition part 11a5 are transmitted to the video switcher 20. In this embodiment, the transmission from the composition part 11a5 to the video switcher 20 is performed via HDMI (registered trademark, High-Definition Multimedia Interface), and the information of the content video and the information of the transparency are mapped in the composition part 11a5 to fit within 24 bits, and then transmitted to the video switcher 20 by HDMI. This allows a composite video of the content video created by the PC 1 and the video of the video switcher 20 to be superimposed thereon to be output from the projector 22.

It should be noted that the transmission from the composition part 11a5 to the video switcher 20 is not necessarily performed via HDMI, and may be performed using other standards. Furthermore, the information of the content video and the information of the transparency are not necessarily mapped so as to fit within 24 bits, but may be equal to or more than 24 bits or less than 24 bits. The information of the content video and the information of the transparency are not necessarily transmitted via a single HDMI signal line, and each may be transmitted via a single HDMI signal line. That is to say, the information of the content video and the information of the transparency may be transmitted via two HDMI signal lines, respectively.

Next, the content table 11b will be described with reference to FIG. 6B. FIG. 6B is a diagram schematically showing the content table 11b. As shown in FIG. 6B, in the content table 11b, the content data, the editing screen data constituting the editing screen for editing the aspect of the content, and the setting data in which the setting state of the aspect of the content is stored are stored in correspondence with each other for each content held by the PC 1, that is, for each content to be arranged in the user content area 42 described above in FIG. 2A to FIG. 2G and FIG. 3A to FIG. 3B. In addition to these content data, editing screen data, and setting data, the videos, images, or audios that constitute the content video, and the videos or images that constitute the editing screen 45 are stored in correspondence with the content data, the editing screen data, and the setting data.

Here, the content data and the editing screen data stored in the content table 11b will be described with reference to FIG. 7A and FIG. 7B. FIG. 7A is a diagram illustrating the content data, and FIG. 7B is a diagram illustrating the editing screen data. As described above, the content data and the editing screen data are respectively written in HTML, and are stored in the content table 11b in the form of text data.

For example, in the content data, the positions (coordinates) and sizes of the images and videos to be arranged, and the settings of start animation and end animation are written according to HTML. In addition, in the editing screen data, the arrangement of operators for setting the positions and sizes of the images and videos included in the target content, and control over the reflection of settings when operating the arranged operators are written according to HTML.

In this embodiment, in a case where the thumbnail button 50a, etc. of the content button 50 is selected from the user content area 42 in which a list of contents is displayed, the content data of the corresponding content is loaded into the output parts 11a2 and 11a3 and interpreted, and the resulting content video is output to the video switcher 20. On the other hand, in a case where the selected thumbnail button 50a, etc. is selected again, the output of the content video based on the corresponding content to the video switcher 20 is stopped.

Here, the content data loaded into the output parts 11a2 and 11a3 is written in HTML which allows the configuration of the content video to be output to be read by human. Thus, the user H can easily change the configuration of the content video by directly editing the content data without using other programs or the like.

In addition, since the editing screen data of the editing screen 45 for setting the aspect of the content is also written in human-readable HTML, the user H can easily change the configuration of the editing screen 45 by directly editing the editing screen data without using other programs or the like. For example, even if the user H adds an image to the content video, the user H can easily add an operator for setting the aspect of the added image by editing the editing screen data.

Returning to FIG. 5, the communication device 15 is a device that communicates with other information processing devices such as the server 70 via the Internet Nt. Via the communication device 15 and the Internet Nt, the PC 1 acquires the content data, the editing screen data, and the setting data of the content stored in the server 70, as well as the videos, images, or audios that constitute the content.

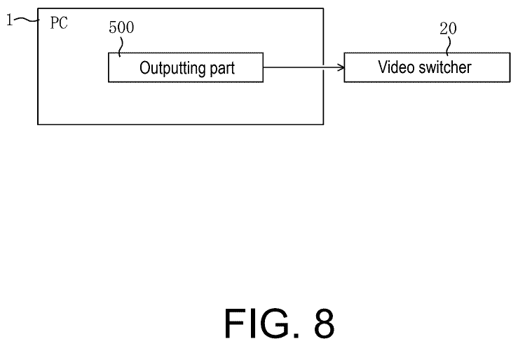

Next, the functions of the PC 1 will be described with reference to FIG. 8. FIG. 8 is a functional block diagram of the PC 1. As shown in FIG. 8, the PC 1 includes an outputting part 500.

The outputting part 500 is a part for loading content data, which is included in an output target content selected from a plurality of contents and in which the configuration of the content video of the output target content is written in a human-readable format, into the output parts 11a2 and 11a3 and outputting the content video based on the content data to the video switcher 20, and is realized by the CPU 10.

That is, the content video output to the video switcher 20 by the output parts 11a2 and 11a3 is configured based on the content data, and the content data describes the configuration of the content in a human-readable format. This allows the user H to directly edit the content data and easily change the configuration of the content without using other programs or the like.

Next, the processes executed by the CPU 10 in accordance with the video output program 11a will be described with reference to FIG. 9 to FIG. 12A and FIG. 12B. In the following, mainly the processing contents of the controller 11a1, the output parts 11a2 and 11a3, and the editing part 11a4 in the video output program 11a described above in FIG. 6A and the flow of data between these modules will be illustrated in the sequence diagrams of FIG. 9 to FIG. 12A and FIG. 12B.

FIG. 9 is a sequence diagram showing a content start process. The content start process is a process in which the user content area 42, etc. is displayed on the display device 4, contents are selected by pressing the thumbnail button 50a, etc. in the user content area 42, etc., and a content video based on the selected contents is output to the video switcher 20.

In the content start process, the controller 11a1 first displays a list of contents, that is, the preset content area 40 and the user content area 42, on the display device 4 (T1). After the processing of T1, the contents corresponding to the thumbnail buttons 50a and 51a and the foreground buttons 50b and 51b selected by the user H via the mouse 2, etc. are acquired (T2).

After the processing of T2, the corresponding output parts 11a2 and 11a3 are instructed to load the content data of the selected contents (T3). Specifically, the content data of the selected contents and the videos, images, or audios constituting the content video of the contents are acquired from the server 70 or the content table 11b. In a case where the thumbnail buttons 50a and 51a are selected, an instruction to load the content data together with the acquired content data and the videos, images, or audios constituting the content video of the contents is transmitted to the background video output part 11a2. Further, in a case where the foreground buttons 50b and 51b are selected, an instruction to load the content data together with the acquired content data and the videos, images, or audios that constitute the content video of the contents is transmitted to the foreground video output part 11a3.

Hereinafter, in a case where the thumbnail buttons 50a and 51a are selected or deselected, the instruction from the controller 11a1 to the output parts 11a2 and 11a3 is an instruction from the controller 11a1 to the background video output part 11a2; and in a case where the foreground buttons 50b are 51b are selected or deselected, the instruction is an instruction from the controller 11a1 to the foreground video output part 11a3.

After the processing of T3, the editing part 11a4 is instructed to load the editing screen data of the selected content (T4). Specifically, the editing screen data of the selected content and the videos or images constituting the editing screen 45 are acquired from the server 70 or the content table 11b, and an instruction to load the editing screen data together with the acquired editing screen data and the videos or images constituting the editing screen 45 is sent to the editing part 11a4. It should be noted that in a case where the editing screen 45 is not displayed, the instruction in the processing of T4 and the instruction in the processing of T9 described below are not performed.

In a case where the output parts 11a2 and 11a3 receive the instruction to load by the processing of T3, the output parts 11a2 and 11a3 load the content data transmitted together with the instruction (T5). At this time, the videos, images, or audios constituting the content video, which are transmitted together with the content data, are also loaded. After the processing of T5, a notification that the loading of the content data is completed is transmitted to the controller 11a1 (T6).

Further, in a case where the editing part 11a4 receives the instruction to load by the processing of T4, the editing part 11a4 loads the editing screen data transmitted together with the instruction (T7). At this time, the videos or images transmitted together with the editing screen data are also loaded. After the processing of T7, a notification that the loading of the editing screen data is completed is transmitted to the controller 11a1 (T8).

In a case where the controller 11a1 receives the notification that the loading is completed from the output parts 11a2 and 11a3 by the processing of T6, and the notification that the loading is completed from the editing part 11a4 by the processing of T8, the controller 11a1 instructs the corresponding output parts 11a2 and 11a3 and the editing part 11a4 to load the setting data of the selected content (T9). Specifically, the setting data of the selected content is acquired from the server 70 or the content table 11b, and the acquired setting data is transmitted to the output parts 11a2 and 11a3 and the editing part 11a4 together with an instruction to load the setting data.

In a case where the output parts 11a2 and 11a3 receive the instruction to load by the processing of T9, the output parts 11a2 and 11a3 load the setting data transmitted together with the instruction (T10). After the processing of T10, a notification that the loading of the setting data is completed is transmitted to the controller 11a1 (T11). Similarly, in a case where the editing part 11a4 receives the instruction to load by the processing of T9, the editing part 11a4 loads the setting data transmitted together with the instruction (T12) and transmits a notification that the loading of the setting data is completed to the controller 11a1 (T13).

In a case where the controller 11a1 receives the notification that the loading is completed from the output parts 11a2 and 11a3 by the processing of T11, and the notification that the loading is completed from the editing part 11a4 by the processing of T13, the controller 11a1 transmits an instruction to start outputting the content (T14).

In a case where the output parts 11a2 and 11a3 receive the instruction to start outputting the content by the processing of T14, the output parts 11a2 and 11a3 start creating the content video by interpreting the content data loaded in the processing of T5 while applying the setting data loaded in the processing of T10. First, in a case where the content data includes a start animation, a description corresponding to the start animation in the content data is interpreted to create a content video based on the start animation, which is output to the video switcher 20 via the composition part 11a5 (T15).

After the processing of T15, in a case where the start animation has ended, such a message is transmitted to the controller 11a1 (T16). In a case where the content data does not include a start animation, the processing of T15 and T16 is skipped.

After the processing of T16, the output parts 11a2 and 11a3 create a content video to be displayed after the start animation based on the content data, and output the content video to the video switcher 20 via the composition part 11a5 (T17). After the processing of T17, a message that the content video to be displayed after the start animation is being output is transmitted to the controller 11a1 (T18).

The editing part 11a4 interprets the editing screen data loaded in the processing of T7 while applying the setting data loaded in the processing of T12, thereby creating the editing screen 45 and outputting the editing screen 45 to the display device 4 (T19).

As described above, in a case where there are contents selected in the user content area 42, etc., the setting data of the contents is loaded into the output parts 11a2 and 11a3 together with the content data, and is applied to the content video based on the content data. This makes it possible to reliably reflect the aspects of the contents set by the user H in the setting data in the content video from the start of output of the content video.

Furthermore, the setting data of the contents is loaded into the output parts 11a2 and 11a3, and the setting data is also loaded into the editing part 11a4, and is also reflected on the editing screen 45. This makes it possible to prevent inconsistencies from occurring between the aspect of the content video output to the video switcher 20 and the settings displayed on the editing screen 45.

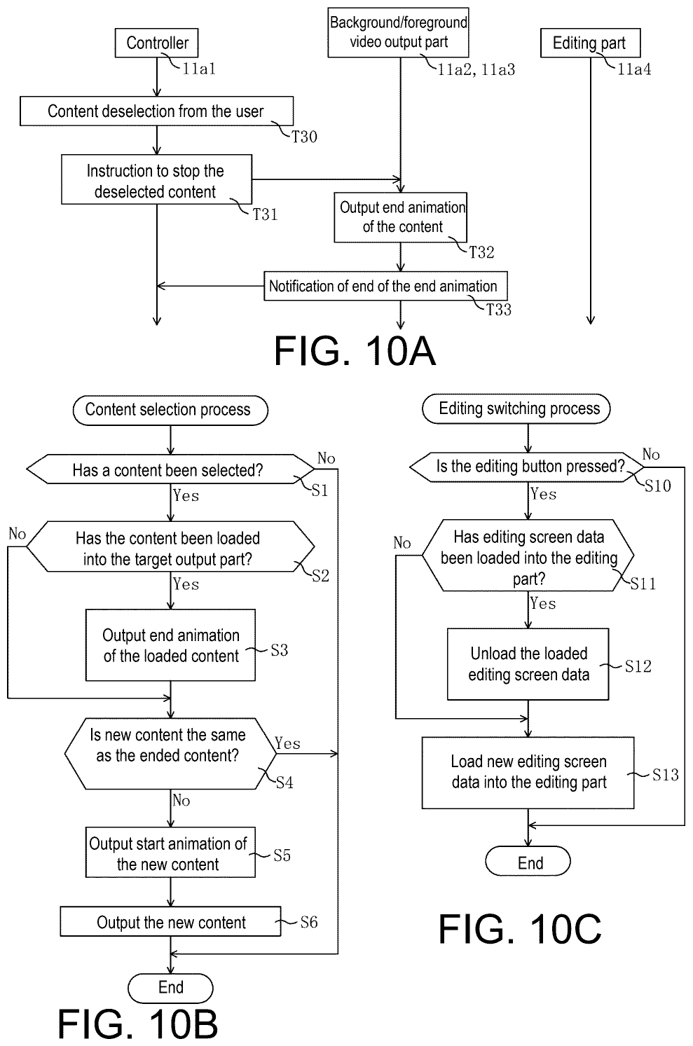

Next, the process to be performed in a case where a selected content is deselected will be described with reference to FIG. 10A. FIG. 10A is a sequence diagram showing a content deselection process. The content deselection process is a process for displaying an end animation in a case where the content selected in the user content area 42, etc. is deselected.

In the content deselection process, the controller 11a1 first acquires the contents corresponding to the thumbnail buttons 50a and 51a and the foreground buttons 50b and 51b deselected by the user H via the mouse 2, etc. (T30).

After the processing of T30, an instruction to stop outputting the content is transmitted to the output parts 11a2 and 11a3 which are outputting the deselected content (T31). At the time when the output parts 11a2 and 11a3 receive the instruction to stop outputting the content by the processing of T31, if the loaded content data includes an end animation, the output parts 11a2 and 11a3 interpret the description corresponding to the end animation in the content data, thereby creating a content video based on the end animation and outputting the content video to the video switcher 20 via the composition part 11a5 (T32).

In a case where the end animation based on the processing of T32 has ended, the controller 11a1 is notified that the end animation has ended (T32). Then, in a case where the loaded content data does not include an end animation, or after the end animation has ended, the output of the content video performed by the output parts 11a2 and 11a3 is stopped.

As described above, in a case where a content is deselected and the content includes an end animation, the output of the content to the video switcher 20 is stopped after the end animation is output. This makes it possible to prevent a situation that the output of the content to the video switcher 20 suddenly stops even though the content includes an end animation, thereby preventing the viewer from feeling incongruity about the content.

Next, the detailed process for a case where a new content is selected when a content has already been selected will be described with reference to FIG. 10B. FIG. 10B is a flowchart of a content selection process. The content selection process is a process executed by the CPU 10 periodically (for example, every 100 milliseconds) after the user content area 42, etc. is displayed on the display device 4.

The content selection process first checks whether a content has been selected by selecting the thumbnail buttons 50a and 51a, etc. (S1). In the processing of S1, in a case where the selection of a content is confirmed (S1: Yes), it is confirmed whether the content data has been loaded into the target output parts 11a2 and 11a3 (S2).

In the processing of S2, specifically, in a case where a content is selected by selecting the thumbnail buttons 50a and 51a in the processing of S1, it is confirmed whether the content data has been loaded into the background video output part 11a2; and in a case where a content is selected by selecting the foreground buttons 50b and 51b in the processing of S1, it is confirmed whether the content data has been loaded into the foreground video output part 11a3.

In a case where it is confirmed in the processing of S2 that the content data has been loaded into the target output parts 11a2 and 11a3 (S2: Yes), the end animation included in the content data loaded into the target output parts 11a2 and 11a3 is output to the video switcher 20 (S3). The processing of S1 to S3 is processing equivalent to the content selection process in FIG. 10A. After the end animation ends, the content data loaded into the target output parts 11a2 and 11a3 is unloaded from the output parts 11a2 and 11a3.

On the other hand, in a case where it is confirmed in the processing of S2 that the content data has not been loaded into the target output parts 11a2 and 11a3 (S2: No), the processing of S3 is skipped. In a case where the content data loaded into the target output parts 11a2 and 11a3 does not include an end animation, the processing of S3 is also skipped.

After the processing of S2 and S3, it is confirmed whether the new content selected in the processing of S1 is the same as the content in which the end animation is output in the processing of S3 (S4). In the processing of S3, whether or not the new content is the same as the content in which the end animation is output in the processing of S3 may be determined, for example, by whether the identification numbers assigned to the contents match, by whether all of the images and videos that constitute the contents match, or by other methods.

In the processing of S4, in a case where the new content is different from the content in which the end animation is output in the processing of S3 (S4: No), the content video based on the start animation of the new content is output to the video switcher 20 (S5), and after the start animation ends, the content video displayed after the start animation is output to the video switcher 20 (S6). The processing of S5 and S6 is processing equivalent to the content start process in FIG. 9. In the processing of S4, in a case where the new content is the same as the content in which the end animation is output in the processing of S3 (S4: Yes), the processing of S5 and S6 is skipped.

That is, when a new content is selected while a different content has already been loaded and output to the output parts 11a2 and 11a3 which output the content video, if the already loaded content includes an end animation, the output of the new content is started after the end animation is output. Thus, the new content is started after the loaded content is properly ended, so it is possible to prevent the loaded content from suddenly switching to the new content, and prevent the viewer from feeling incongruity about the switching between the contents.

Furthermore, in a case where the new content has the same content data as the content already loaded into the corresponding output parts 11a2 and 11a3, the output of the content to the video switcher 20 is stopped after the end animation of the content is output. This prevents the same content from being repeatedly output by the same output parts 11a2 and 11a3, and reduces the incongruity felt by the viewer about the output content.

After the processing of S1, S4, and S6, the content selection process ends.

Next, in a case where the editing buttons 50c and 51c (see FIG. 2A to FIG. 2G) are selected, a process of switching the editing screen 45 to a screen for editing the aspect of the content of the selected editing buttons 50c and 51c will be described with reference to FIG. 10C. FIG. 10C is a flowchart of an editing switching process. The editing switching process is a process executed by the CPU 10 periodically (for example, every 100 milliseconds) after the user content area 42, etc. is displayed on the display device 4.

The editing switching process first checks whether the editing buttons 50c and 51c are pressed (S10). In a case where it is confirmed in the processing of S10 that the editing buttons 50c and 51c are pressed (S10: Yes), it is confirmed whether the editing screen data has been loaded into the editing part 11a4 (S11). In a case where it is confirmed in the processing of S11 that the editing screen data has been loaded into the editing part 11a4 (S11: Yes), the editing screen data loaded into the editing part 11a4 is unloaded (S12). On the other hand, in a case where it is not confirmed in the processing of S11 that the editing screen data has been loaded into the editing part 11a4 (S11: No), the processing of S12 is skipped.

After the processing of S11 and S12, the editing screen data of the content corresponding to the editing buttons 50c and 51c pressed in the processing of S10 is acquired from the server 70 or the content table 11b, and loaded into the editing part 11a4 (S13). At this time, the setting data of the content corresponding to the editing buttons 50c and 51c is also acquired from the server 70 or the content table 11b, and loaded into the editing part 11a4.

In a case where new editing screen data and setting data are loaded into the editing part 11a4, an editing screen 45 based on the new editing screen data is created by processing similar to the processing of T19 in FIG. 9, and output to the display device. As a result of the above, the editing screen 45 for setting the aspect of the content for which the editing buttons 50c and 51c are pressed is displayed on the display device 4.

After the processing of S10 and S13, the editing switching process ends.

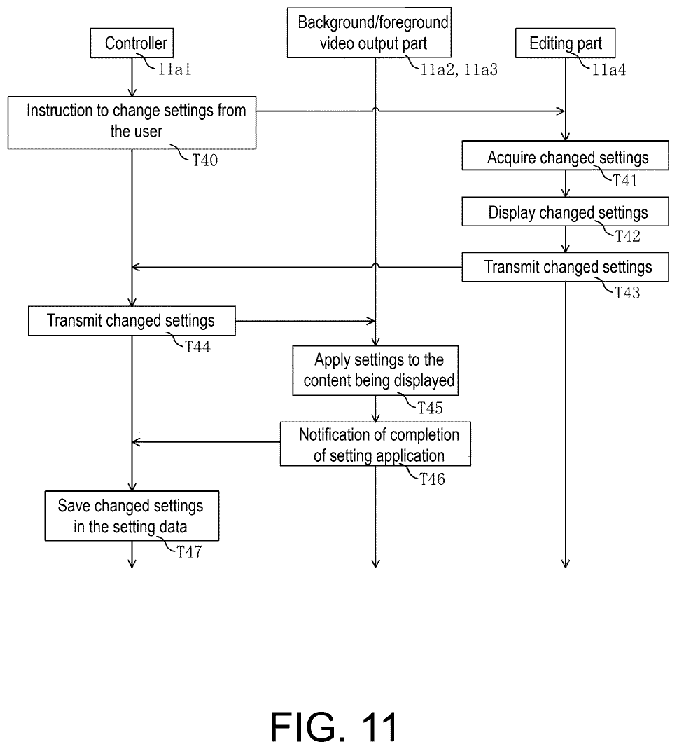

Next, a process related to the editing of the aspect of the content by the editing screen 45 will be described with reference to FIG. 11. FIG. 11 is a sequence diagram of a content editing process. In a case where the controller 11a1 detects an operation of the user H on the editing screen 45 via the mouse 2, etc., the content editing process first transmits an instruction to change the settings of the aspect of the content and information of the changed settings (hereinafter referred to as “changed setting information”) to the editing part 11a4 (T40).

In a case where the editing part 11a4 receives the instruction to change the settings of the aspect of the content and the changed setting information by the processing of T40, the editing part 11a4 acquires the changed setting information (T41) and changes the aspect of the editing screen 45 based on the changed setting information (T42). For example, in a case where the position of an image included in the target content is changed, the coordinate value indicating the position, which is displayed on the editing screen 45, is changed. After the processing of T42, the editing part 11a4 transmits the changed setting information to the controller 11a1 (T43).

In a case where the controller 11a1 receives the changed setting information from the editing part 11a4 by the processing of T43, the controller 11a1 transmits the changed setting information to the corresponding output parts 11a2 and 11a3 (T44). In a case where the output parts 11a2 and 11a3 receive the changed setting information from the controller 11a1 by the processing of T44, the changed setting information is applied to the aspect of the content that is being output to the video switcher 20 (T45). After the processing of T45, a notification that the changed setting information is applied to the aspect of the content being output is transmitted to the controller 11a1 (T46).

Further, in a case where the controller 11a1 receives the notification that the changed setting information from the output parts 11a2 and 11a3 is applied to the aspect of the content being output by the processing of T46, the controller 11a1 applies the changed setting information to the corresponding setting data in the server 70 or the content table 11b (T47).

That is, in a case where the settings of the aspect of the content are changed on the editing screen 45, the changed setting information is first reflected in the editing part 11a4, and then, via the controller 11a1, the changed setting information is transmitted to the output parts 11a2 and 11a3 and applied to the content being output.

This allows the settings of the aspect of the content on the editing screen 45 to be applied to the content being output in real time. In addition, since the changed setting information for setting the aspect of the content is transmitted to the editing part 11a4 and the output parts 11a2 and 11a3 via the controller 11al, it is possible to prevent inconsistencies between the display of the editing screen 45 and the aspect of the content being output. Also, since there is no need to set up a communication path for communication between the editing part 11a4 and the output parts 11a2 and 11a3, the editing part 11a4 and the output parts 11a2 and 11a3 can be configured simply.

Furthermore, the changed setting information is applied to the corresponding setting data in the server 70 or the content table 11b, so the current changed setting information can be applied the next time a content with a changed aspect is output.

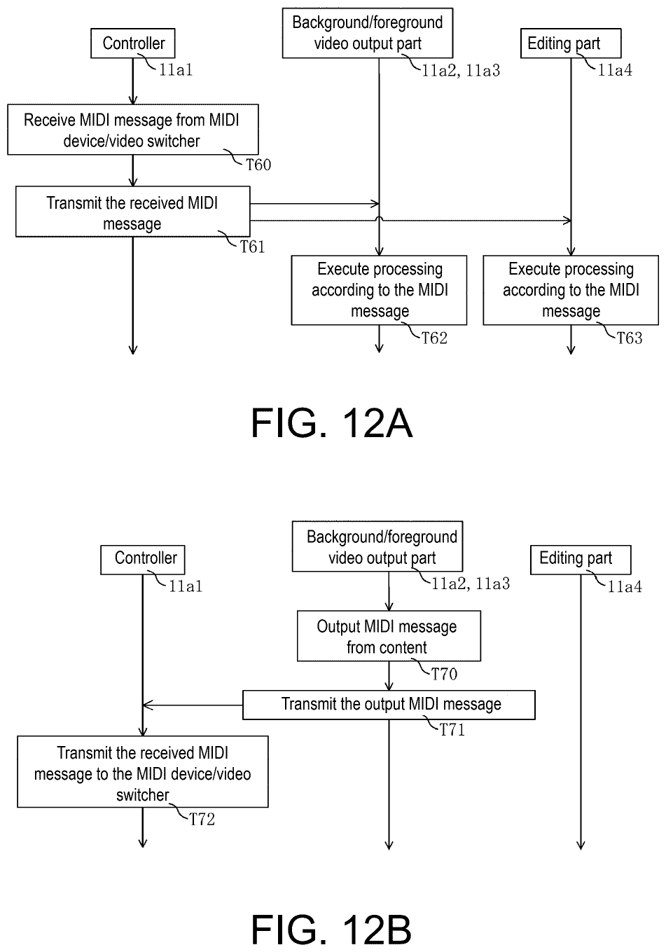

Finally, a process related to the control of the content or the editing screen 45 from the MIDI device 5 or the video switcher 20, and a process related to the control of the MIDI device 5 or the video switcher 20 from the content will be described with reference to FIG. 12A and FIG. 12B. FIG. 12A is a sequence diagram of a case where the content or the editing screen 45 is controlled from the MIDI device 5 or the video switcher 20.

In a case of controlling the content or the editing screen 45 from the MIDI device 5 or the video switcher 20, first, the controller 11a1 receives a MIDI message from the MIDI device 5 or the video switcher 20 (T60), and transmits the MIDI message to the output parts 11a2 and 11a3 and the editing part 11a4 (T61).

In a case where the output parts 11a2 and 11a3 receive the MIDI message by the processing of T61, the output parts 11a2 and 11a3 execute processing according to the MIDI message (T62). Further, in a case where the editing part 11a4 receives the MIDI message by the processing of T61, the editing part 11a4 executes processing according to the MIDI message (T63).

An example of the processing of T62 in the output parts 11a2 and 11a3 is to display/hide one image of a certain content being output by the output parts 11a2 and 11a3 in a case where the received MIDI message is a control change “CC #0:0”. In this case, the processing content, such as displaying/hiding one image according to the MIDI message received in the content, may be written in the content data.

Further, an example of the processing of T63 in the editing part 11a4 is to increase or decrease the value of one operator on the editing screen 45 being output by the editing part 11a4 in a case where the received MIDI message is a control change “CC #13:8”. In this case, the processing content, such as increasing or decreasing the value of one operator 1 according to the MIDI message received in the content, may be written in the editing screen data.

It should be noted that the processing of the MIDI message from the MIDI device 5 or the video switcher 20 is not necessarily performed by the output parts 11a2 and 11a3 or the editing part 11a4, but may also be performed by the controller 11al. For example, in a case where the received MIDI message is a program change “PC: 100”, the controller 11a1 may perform the same operation as when the thumbnail button 50a or the foreground button 50b of the content associated with the program change value is operated (the processing after T2 in FIG. 9 or the processing after T30 in FIG. 10A). In a case where the controller 11a1 performs processing based on the received MIDI message in this manner, the transmission of the MIDI message to the output parts 11a2 and 11a3 and the editing part 11a4 by the processing of T61 may be omitted.

As the processing according to MIDI message from the video switcher 20 or the MIDI device 5 is executed by the output parts 11a2 and 11a3 in this manner, the user H can easily change the content or the editing screen 45 output from the output parts 11a2 and 11a3 or the editing part 11a4 without editing the content data or operating the output parts 11a2 and 11a3 or the editing part 11a4.

FIG. 12B is a sequence diagram of a case where the MIDI device 5 or the video switcher 20 is controlled from the content. In a case of controlling the content or the editing screen 45 from the MIDI device 5 or the video switcher 20, when the content data includes the output of a MIDI message, the output parts 11a2 and 11a3 transmit the MIDI message (T70) and transmit the output MIDI message to the controller 11a1 (T71).

In a case where the controller 11a1 receives the MIDI message from the output parts 11a2 and 11a3 by the processing of T71, the controller 11a1 transmits the MIDI message to the MIDI device 5 and the video switcher 20 (T72). In the MIDI device 5 and the video switcher 20 to which the MIDI message is transmitted, processing according to the MIDI message is performed.

For example, the following processing is an example of the processing performed by the video switcher 20 according to the MIDI message. In the video switcher 20, the MIDI message of a corresponding control change is assigned in advance for each input channel to which the video camera 21, etc. is connected (for example, a control change “CC #55:01” is assigned to the input channel to which the video camera 21a of the two video cameras 21 is connected, and a control change “CC #55:02” is assigned to the input channel to which the video camera 21b is connected), and the video switcher 20 is set to switch the video camera 21 that acquires the video to be output to the projector 22 to the video camera 21 that corresponds to the received MIDI message in a case of receiving the MIDI message.

In a case where a MIDI message (for example, a control change “CC #55”) is created based on the description of the content data from the output parts 11a2 and 11a3 and transmitted to the video switcher 20, the video switcher 20 switches the video camera 21 that acquires the video to be output to the projector 22 to the video camera 21 that corresponds to the value (that is, “00” or “01”) set in the control change “CC #55” of the received MIDI message.

Thus, by writing in the content data that a MIDI message is to be output, and transmitting a MIDI message based on the content data to the MIDI device 5 or the video switcher 20 and performing processing according to the MIDI message received by the MIDI device 5 or the video switcher 20, it is possible to control the MIDI device 5 or the video switcher 20 from the content data.

Therefore, for example, by transmitting a MIDI message to the video switcher 20 according to a change in the aspect of the content, an expressive video which combines a change in the aspect of the content with a change in the processing of the video switcher 20, such as switching between the video cameras 21, can be output from the video switcher 20.

Although the disclosure has been described based on the above embodiment, it can be easily inferred that various improvements and modifications are possible.

In the above embodiment, two contents, that is, the foreground content and the background content, can be selected as the output target content, but the disclosure is not limited thereto. For example, only one content may be selected as the output target content, or three or more contents may be selected as the output target content. Similarly, the composite content is composed of two contents, but the disclosure is not limited thereto, and the composite content may be composed of three or more contents.

In the above embodiment, the content data and the editing screen data are written in HTML, but the disclosure is not limited thereto. The content data and the editing screen data may be written in other human-readable formats, for example, in high-level languages such as C language or Python, or even if not written in high-level languages, the content arrangement, size, or the like may be written according to certain rules. Furthermore, the content data and the editing screen data are not necessarily both written in HTML. For example, the content data may be written in HTML and the editing screen data may be written in C language, or the content data may be written in C language and the editing screen data may be written in HTML.

In the above embodiment, the video output program 11a includes all of the modules of the controller 11a1, the output parts 11a2 and 11a3, the editing part 11a4, and the composition part 11a5, but the disclosure is not limited thereto. Some modules of the video output program 11a may be executed by another program. For example, the video output program 11a may be configured so that the only module included in the video output program 11a is the controller 11a1, and the other modules, that is, the output parts 11a2 and 11a3, the editing part 11a4, and the composition part 11a5, are included in one or more other programs.

In the above embodiment, in the user content area 42 where the auto tab 44 in FIG. 3A and FIG. 3B is selected, if the sequence is not looped, the contents are switched and output in order from the content selected by the user H to the right, but the disclosure is not limited thereto. For example, the contents may be switched and output in order from the content selected by the user H to the right.

Furthermore, in the user content area 42 where the auto tab 44 is selected, if the sequence is looped, the contents of the content buttons 50 arranged within the range between the start point designation button 42a or the leftmost content and the end point designation button 42b are output in order from the content of the leftmost content button 50 to the right, but the order in which the contents are output is not limited thereto. For example, the contents of the content buttons 50 arranged within the range between the start point designation button 42a or the leftmost content and the end point designation button 42b may be switched and output in order from the content of the rightmost content button 50 to the left, or the contents of the content buttons 50 arranged within the range between the start point designation button 42a or the leftmost content and the end point designation button 42b may be switched and output in random order.

In the above embodiment, in FIG. 12A and FIG. 12B, a MIDI message is used as a control signal for controlling the content of the PC 1 from the MIDI device 5 or the video switcher 20, but the disclosure is not limited thereto, and the content in the PC 1 may be controlled from the MIDI device 5 or the video switcher 20 using a control signal other than a MIDI message. Similarly, a MIDI message is used as a control signal for controlling the MIDI device 5 or the video switcher 20 from the content of the PC 1, but the disclosure is not limited thereto, and other control signals such as RS-232C or LAN may also be used.

In the above embodiment, the input source for inputting a video to the video switcher 20 is the video camera 21, but the disclosure is not limited thereto, and a video may be input from other devices such as a game machine. Furthermore, a video stored (recorded) in the PC 1, the server 70, a video deck, or the like may be input to the video switcher 20.

In the above embodiment, pre-created contents are stored in the server 70, but the disclosure is not limited thereto. For example, pre-created contents may be stored in an external memory (not shown), and the external memory may be connected to the PC 1, thereby allowing the PC 1 to acquire the pre-created contents. Furthermore, pre-created contents may be stored in the video switcher 20 or other devices, and the PC 1 may acquire the pre-created contents from these devices.

In the above embodiment, the video switcher 20 is exemplified as an external device, but the disclosure is not limited thereto, and other devices that output a video to the display device such as the projector 22 may be used as the external device. Moreover, the video camera 21 and the projector 22 may be connected to the PC 1, and the function of the video switcher 20 (external device) may be integrated into the PC 1. Alternatively, the function of the PC 1 may be integrated into the video switcher 20 by executing the video output program 11a in the video switcher 20.

Although the PC 1 is exemplified as a computer that executes the video output program 11a, the disclosure is not limited thereto. For example, the video output program 11a may be executed on a computer such as a smartphone or a tablet terminal. Alternatively, the video output program 11a may be stored in a ROM or the like, and the disclosure may be applied to a dedicated device (tone output device) that executes only the video output program 11a.

What is claimed is:

1. A non-transitory recording medium storing a video output program for causing a computer, to which an external device is connected, to execute a process of outputting a content video that is a video created based on contents comprising at least one of a video and an image,
wherein the contents comprise content data in which a configuration of the content video is written in a human-readable format,
the computer comprises an output part that generates the content video based on the content data and outputs the content video to the external device, and
the video output program causes the computer to load content data included in an output target content selected from a plurality of the contents into the output part and output the content video based on the content data to the external device.

2. The recording medium according to claim 1, wherein for each of the contents, setting data is provided, in which a setting state of an aspect of the content is stored, and
the content data corresponding to the selected output target content and the setting data corresponding to the content data are loaded into the output part, and the content video in which the setting data is applied to the loaded content data is output to the external device.

3. The recording medium according to claim 2, wherein the computer further comprises an editing part that edits the setting data, and a controller that controls the output part and the editing part, and
the video output program further causes the computer to:
edit the setting data by the editing part;
transmit the edited setting data to the controller;
transmit the setting data transmitted to the controller to the output part; and
apply the setting data transmitted to the output part to the content being output by the output part.

4. The recording medium according to claim 3, wherein the content data corresponding to the selected output target content and the setting data corresponding to the content data are loaded into the output part, and the setting data and editing screen data, in which a configuration of an editing screen for editing the setting data is written in a human-readable format, are loaded into the editing part,
the video output program further causes the computer to display the editing screen based on the editing screen data, and reflect the setting data on the editing screen in response to the setting data and the editing screen data being loaded into the editing part, and
the setting data is edited using the editing screen displayed by the editing part.

5. The recording medium according to claim 1, wherein the content data comprises data which represents an aspect of the content and a control signal in which a processing content of the external device is written, and
the video output program further causes the computer to transmit the control signal included in the content data to the external device.

6. The recording medium according to claim 3, wherein the video output program further causes the computer to:
receive a control signal from the external device; and
execute a process according to the received control signal in the output part or the editing part.

7. The recording medium according to claim 1, wherein the content data is written in HTML.

8. The recording medium according to claim 4, wherein the editing screen data is written in HTML.

9. The recording medium according to claim 1, wherein a foreground content and a background content different from the foreground content are selected as the output target contents,
the computer comprises, as the output part, a foreground output part that generates a foreground video based on content data included in the foreground content, and a background output part that generates a background video based on content data included in the background content, and
a content video, in which the background video generated by the background output part is superimposed on the foreground video generated by the foreground output part, is output.

10. The recording medium according to claim 2, wherein the content data is written in HTML.

11. The recording medium according to claim 3, wherein the content data is written in HTML.

12. The recording medium according to claim 4, wherein the content data is written in HTML.

13. The recording medium according to claim 5, wherein the content data is written in HTML.

14. The recording medium according to claim 6, wherein the content data is written in HTML.

15. A video output apparatus configured to output a content video that is a video created based on contents comprising at least one of a video and an image, wherein the contents comprise content data in which a configuration of the content video is written in a human-readable format, the video output apparatus comprising a processor configured to:
load content data included in an output target content selected from a plurality of the contents into an output part and output a content video based on the content data to an external device.

16. A video output method for outputting a content video that is a video created based on contents comprising at least one of a video and an image, wherein the contents comprise content data in which a configuration of the content video is written in a human-readable format, the video output method comprising:
loading content data included in an output target content selected from a plurality of the contents into an output part and outputting a content video based on the content data to an external device.
